(19) United States
(12) Patent Application Publication
(10) Pub. No.: US 2025/0030299 A1
(43) Pub. Date: Jan. 23, 2025

(54) POWER UNIT

(71) Applicant: Makita Corporation, Anjo-shi (JP)

(72) Inventors: Takayoshi IIO, Anjo-shi (JP); Tomoyuki KUTSUNA, Anjo-shi (JP)

(73) Assignee: Makita Corporation, Anjo-shi (JP)

(21) Appl. No.: 18/748,290

(22) Filed: Jun. 20, 2024

(30) Foreign Application Priority Data
Jul. 20, 2023 (JP) 2023-118352

(51) Int. Cl. H02K 5/04; H02K 11/20

(52) U.S. Cl. CPC H02K 5/04; H02K 11/20

(57) ABSTRACT

A power unit may include: a prime mover; a body housing supporting the prime mover, and an input unit configured to control the prime mover. The input unit may include: an input unit housing having an internal space and comprising a draw-in part configured to draw in the wire from outside the input unit housing into the internal space; and a fixing part configured to fix the input unit housing to the body housing. The input unit housing may be configured to be fixed to the body housing selectively in any arrangement among at least two arrangements.

### REFERENCE TO RELATED APPLICATIONS

This application claims priority to Japanese Patent Application No. 2023-118352, filed on Jul. 20, 2023, the entire contents of which are hereby incorporated by reference into the present application.

### TECHNICAL FIELD

This disclosure herein relates to a power unit.

### BACKGROUND ART

Japanese Patent Application Publication No. 2000-175310 describes a power unit. The power unit includes a prime mover, a base supporting the prime mover, and an input unit configured to control the prime mover. The input unit includes an input unit body fixed to the base, a draw-in part arranged at the input unit body and configured to draw in a wire into the input unit body, and a fixing part configured to fix the input unit body to the base.

### SUMMARY

In the above-mentioned power unit, the draw-in part is fixed in a specific arrangement to the base. Due to this, the draw-in part cannot be placed in a suitable arrangement according to a type of a working unit when the power unit is used in the working unit. The present disclosure provides an art configured to place the draw-in part in a suitable arrangement according to the type of the working unit.

A power unit disclosed herein may comprise: a prime mover; a body housing supporting the prime mover; and an input unit configured to control the prime mover. The input unit may comprise: an input unit housing having an internal space and comprising a draw-in part configured to draw in the wire from outside the input unit housing into the internal space; and a fixing part configured to fix the input unit housing to the body housing. The input unit housing may be configured to be fixed to the body housing selectively in any arrangement among at least two arrangements.

According to the above configuration, the arrangement of the draw-in part relative to the body housing can be adjusted by changing the arrangement of the input unit housing relative to the body housing. Due to this, the draw-in part can be placed in a suitable arrangement according to the type of the working unit when the power unit is used in the working unit.

### BRIEF DESCRIPTION OF DRAWINGS

FIG. 1 illustrates a perspective view of a power unit 2 and a working unit 4 according to a first embodiment.

FIG. 2 illustrates a perspective view of the power unit 2 according to the first embodiment.

FIG. 3 illustrates a perspective view of the power unit 2 according to the first embodiment.

FIG. 4 illustrates an exploded perspective view of a right body housing 42 and a cover unit 110 according to the first embodiment.

FIG. 5 illustrates an exploded perspective view of a left body housing 44 and an input unit 112 according to the first embodiment.

FIG. 6 illustrates a cross-sectional view of the power unit 2 according to the first embodiment.

FIG. 7 illustrates a perspective view of the power unit 2 according to the first embodiment.

FIG. 8 illustrates a perspective view of the power unit 2 according to the first embodiment.

FIG. 9 illustrates a support member 142 according to the first embodiment.

FIG. 10 illustrates a perspective view of a cover 144 according to the first embodiment.

FIG. 11 illustrates a perspective view of the cover 144 according to the first embodiment.

FIG. 12 illustrates a side view of the input unit 112, a handle 20, and a trigger 22 according to the first embodiment.

FIG. 13 illustrates a side view of the input unit 112, the handle 20, and the trigger 22 according to the first embodiment.

FIG. 14 illustrates a side view showing locations of a draw-in part 188 of the input unit 112 at respective arrangements in the first embodiment.

FIG. 15 illustrates a side view of a power unit 2 according to a second embodiment in proximity to an input unit 112.

FIG. 16 illustrates a side view of a power unit 2 according to a third embodiment in proximity to an input unit 112.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved power units, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, the at least two arrangements may comprise a first arrangement, and a second arrangement different from the first arrangement. The input unit in the first arrangement may be disposed rotationally symmetric to the input unit in the second arrangement with respect to a fixing central axis.

According to the above configuration, no matter what arrangement the input unit is in, a distance between the draw-in part and the fixing central axis can be made constant.

In one or more embodiments, the at least two arrangements may further comprise a third arrangement different from the first arrangement and the second arrangement. The input unit in the third arrangement may be disposed rotationally symmetric to the input unit in the first arrangement with respect to the fixing central axis. An angle about the fixing central axis between the draw-in part of the input unit in the first arrangement and the draw-in part of the input unit in the second arrangement may be same as an angle about the fixing central axis between the draw-in part of the input unit in the second arrangement and the draw-in part of the input unit in the third arrangement.

According to the above configuration, the arrangement of the input unit relative to the body housing can be easily adjusted.

In one or more embodiments, the body housing may comprise a first outer wall to which the input unit housing is configured to be fixed, and a second outer wall to which the input unit housing is configured to be fixed and being different from the first outer wall.

According to the above configuration, an outer wall to which the input unit housing is to be fixed can be selected from among the first outer wall and the second outer wall depending on the type of the working unit. Due to this, the draw-in part can be placed in a suitable arrangement depending on the type of the working unit.

In one or more embodiments, the wire may be configured to move relative to the draw-in part. The input unit may further comprise a detector disposed in the internal space and configured to detect movement of the wire.

According to the above configuration, the input unit can be suppressed from being large in size as compared to a configuration where the detector is disposed outside the input unit housing.

In one or more embodiments, the input unit may further comprise a lever fixed to the wire and configured to operate the detector when the wire moves relative to the draw-in part.

In a configuration where the wire directly operates the detector, there may be an erroneous operation on the detector due to vibration of the wire, for example. According to the above configuration, because the lever operates the detector, the detector can be suppressed from being erroneously operated.

In one or more embodiments, the prime mover may be a motor.

Generally, because a motor is smaller than an engine, the body housing is therefore small. According to the above configuration, in the body housing which is small, the draw-in part can be placed in a suitable arrangement depending on the type of the working unit.

### First Embodiment

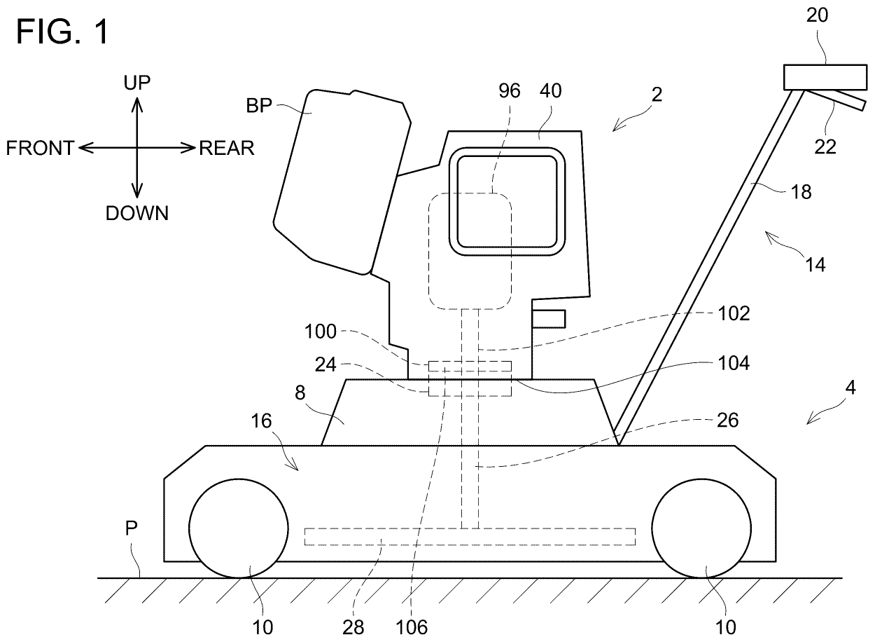

As shown in FIG. 1, a power unit 2 is used by being fixed to a working unit 4. The power unit 2 is configured to be selectively adapted to several types of the working unit 4. The power unit 2 is configured to drive the working unit 4.

The working unit 4 is a walk-behind grass cutter. The working unit 4 comprises a housing 8, a plurality of wheels 10, a handle unit 14, and a work part 16. In FIG. 1, a direction perpendicular to a placement plane P will be referred to as an up-down direction, a direction perpendicular to the up-down direction will be referred to as a front-rear direction, and a direction perpendicular to the up-down and front-rear directions will be referred to as a left-right direction.

The plurality of wheels 10 is rotatably supported by the housing 8. The handle unit 14 comprises a fixing frame 18, a handle 20, and a trigger 22. The fixing frame 18 is fixed to the housing 8. The handle 20 is attached to the fixing frame 18. When the user grips the handle 20 and presses the same frontward, the plurality of wheels 10 rotates. Due to this, the working unit 4 moves on the placement plane P. The trigger 22 is pivotably attached to the handle 20. The trigger 22 is operated by a hand of the user which is gripping the handle 20 so as to approach the handle 20. When the trigger 22 is operated, the power unit 2 operates.

The work part 16 comprises a drum 24, a transmission shaft 26, and a blade 28. The drum 24 is rotatably supported by the housing 8. The blade 28 is fixed to the drum 24 via the transmission shaft 26. When the power unit 2 operates, the drum 24 rotates. Due to this, the blade 28 rotates unitedly with the transmission shaft 26. The rotating blade 28 cuts weed on the placement plane P.

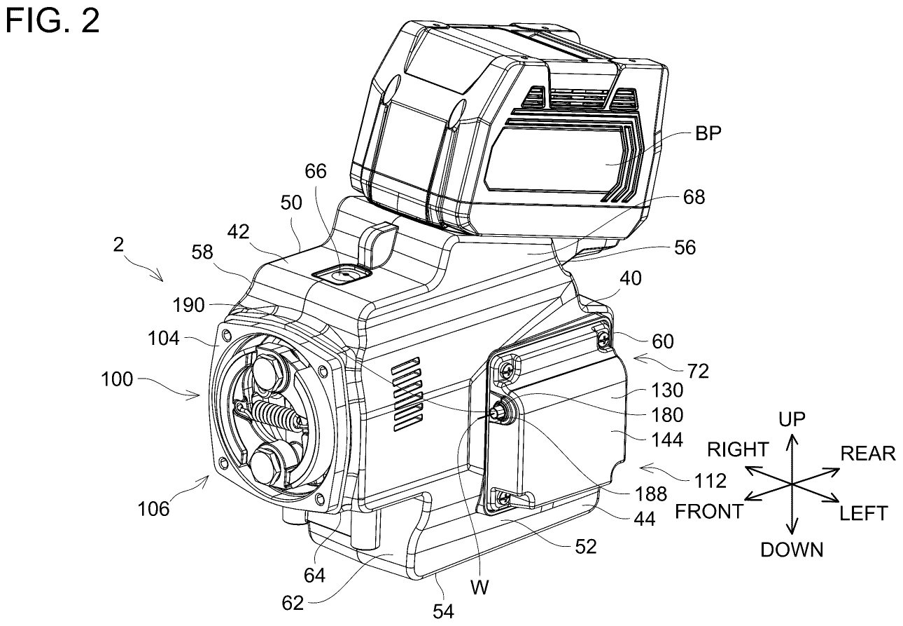

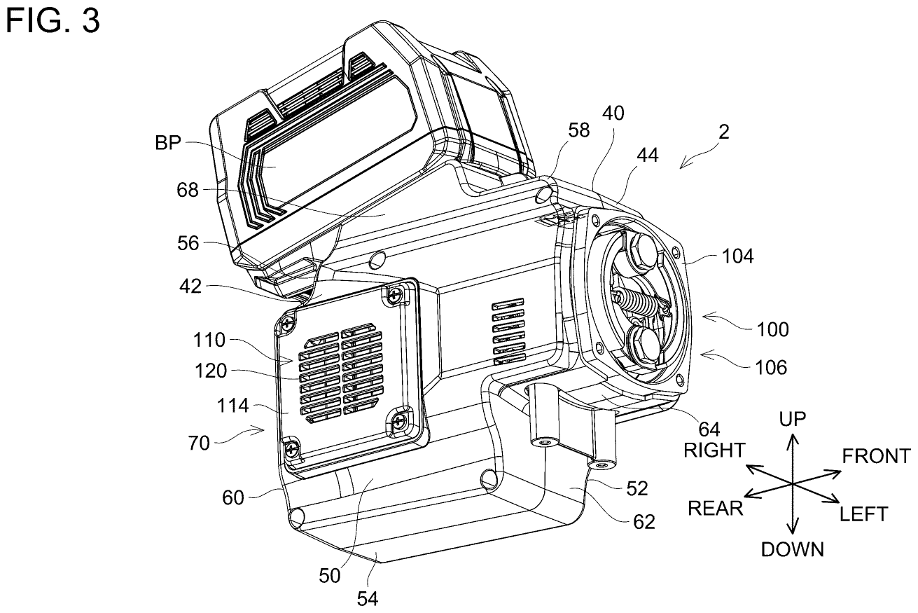

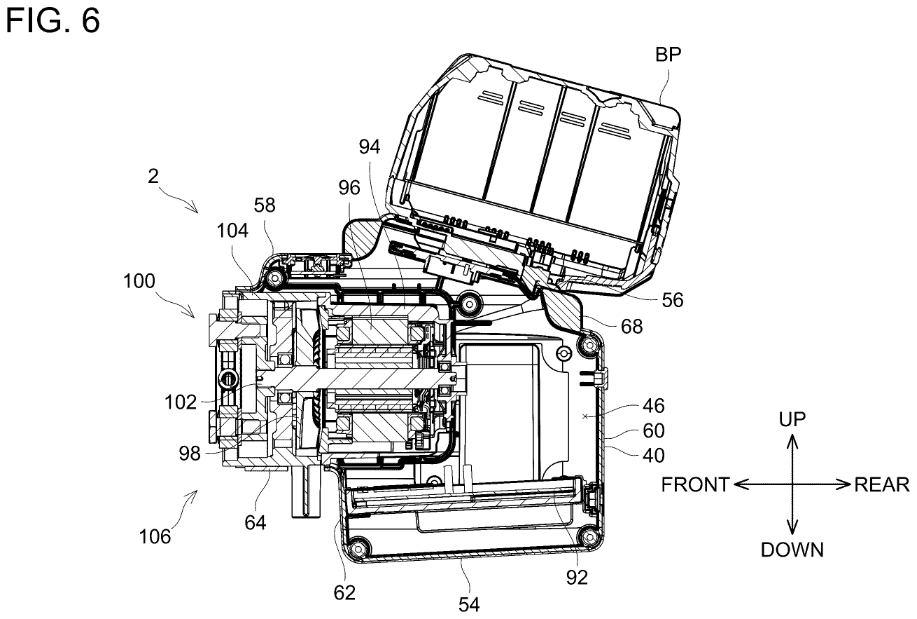

As shown in FIGS. 2 and 3, the power unit 2 operates on power from the battery pack BP. Hereafter, description will be made with the coordinate system changed to a different coordinate system from the above-mentioned coordinate system. Specifically, a direction in which a shaft 102 (see FIG. 6) of a prime mover 96 to be described later extends will be referred to as a front-rear direction, a direction perpendicular to the front-rear direction will be referred to as a left-right direction, and a direction perpendicular to the front-rear direction and the left-right direction will be referred to as an up-down direction.

The power unit 2 comprises a body housing 40. The body housing 40 is constituted of a resin material. The body housing 40 comprises a right body housing 42 and a left body housing 44. The right body housing 42 defines an outer shape of a right half surface of the body housing 40. The left body housing 44 defines an outer shape of a left half surface of the body housing 40.

The right body housing 42 and the left body housing 44 have shapes of the body housing 40 that are divided in halves with respect to a plane including the front-rear direction and the up-down direction. An accommodating space 46 (see FIG. 6) is defined between the right body housing 42 and the left body housing 44.

The body housing 40 comprises a right wall 50, a left wall 52, a lower wall 54, a rear upper wall 56, a front upper wall 58, a rear wall 60, a front vertical wall 62, and a front horizontal wall 64. The left wall 52 is disposed opposite from the right wall 50. The lower wall 54 makes contact with the placement plane P when the power unit 2 is placed on the placement plane P (see FIG. 1).

The rear upper wall 56 and the front upper wall 58 are disposed opposite from the lower wall 54. A main power switch 66 is arranged on the front upper wall 58. The main power switch 66 is configured to accept operation by a user for switching between an on-state and an off-state of the power unit 2. The front vertical wall 62 extends upward from a front end of the lower wall 54. The front horizontal wall 64 extends frontward from an upper end of the front vertical wall 62.

The body housing 40 further comprises a battery attaching part 68, a right fixing part 70, and a left fixing part 72. The battery attaching part 68 is arranged on the rear upper wall 56. The battery attaching part 68 is configured to detachably receive the battery pack BP. The battery pack BP is a rechargeable secondary battery, such as a lithium-ion battery.

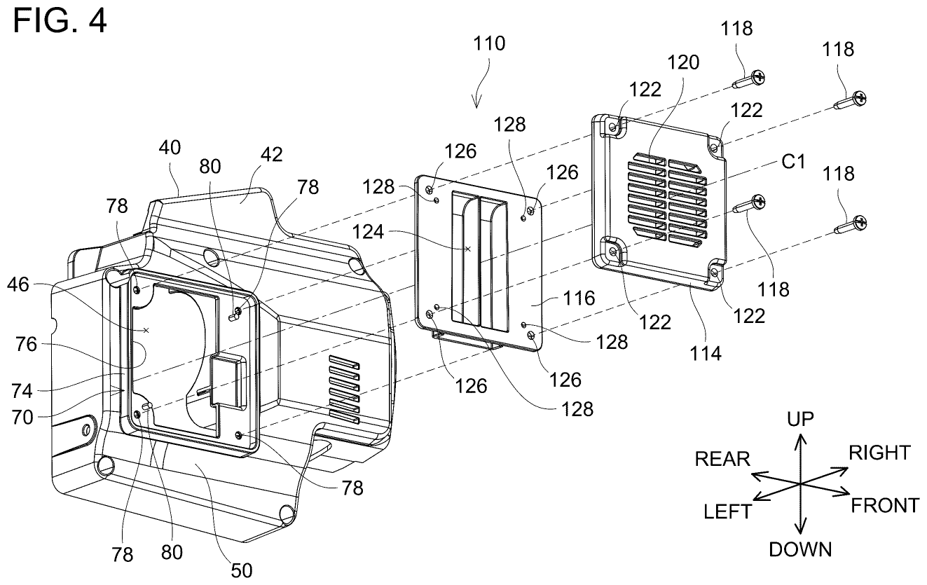

As shown in FIG. 4, the right fixing part 70 is arranged on the right wall 50. The right fixing part 70 comprises a right peripheral wall part 74, a right communicating hole 76, a plurality of (four in the present embodiment) right fixing holes 78, and a plurality of (two in the present embodiment) right positioning protrusions 80.

The right peripheral wall part 74 protrudes rightward from an outer surface of the right wall 50. When the body housing 40 is viewed along the left direction, the right peripheral wall part 74 has a frame shape that is substantially square.

The right communicating hole 76 penetrates the right wall 50 in the left-right direction. The right communicating hole 76 is surrounded by the right peripheral wall part 74. The right communicating hole 76 communicates the accommodating space 46 (see FIG. 6) of the body housing 40 with a space outside the body housing 40.

Each of the right fixing holes 78 penetrates the right wall 50 in the left-right direction. The four right fixing holes 78 are arranged in the right peripheral wall part 74. Each of the four right fixing holes 78 is disposed near a corresponding one of four corners of the right peripheral wall part 74. The right fixing part 70 comprises a right fixing central axis C1 located at a spot equidistant from each of the four right fixing holes 78. About the right fixing central axis C1, the adjacent right fixing holes 78 are apart 90 degrees from each other.

Each of the right positioning protrusions 80 protrudes rightward from the outer surface of the right wall 50. The right positioning protrusions 80 are arranged in the right peripheral wall part 74. The right positioning protrusions 80 are disposed closer to the right fixing central axis C1 than the right fixing holes 78. About the right fixing central axis C1, the two right positioning protrusions 80 are apart 180 degrees from each other.

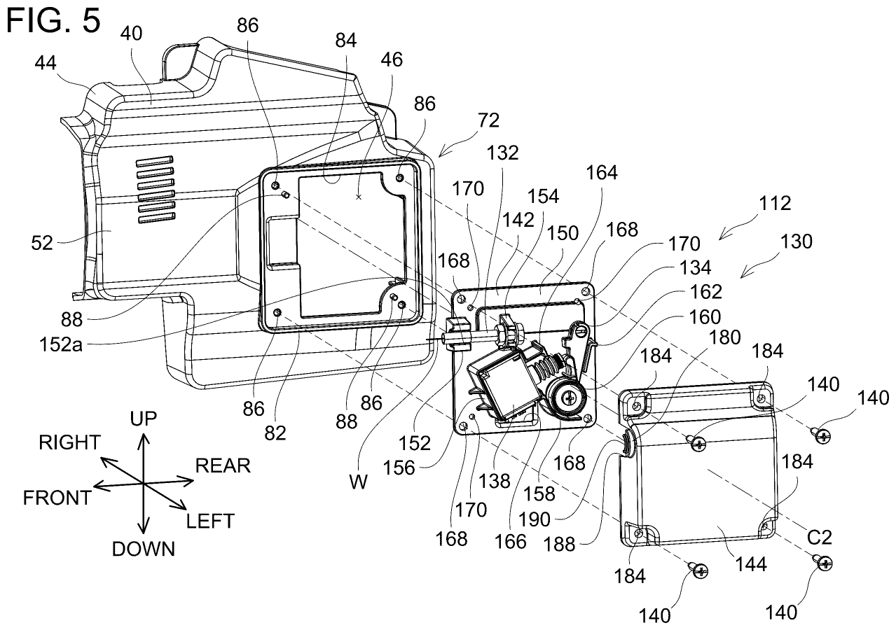

As shown in FIG. 5, the left fixing part 72 is arranged on the left wall 52. The left fixing part 72 comprises a left peripheral wall part 82, a left communicating hole 84, a plurality of (four in the present embodiment) left fixing holes 86, and a plurality of (two in the present embodiment) left positioning protrusions 88.

The left peripheral wall part 82 protrudes leftward from an outer surface of the left wall 52. When the body housing 40 is viewed along the right direction, the left peripheral wall part 82 has a frame shape that is substantially square. The shape of the left peripheral wall part 82 is substantially the same as that of the right peripheral wall part 74.

The left communicating hole 84 penetrates the left wall 52 in the left-right direction. The left communicating hole 84 is surrounded by the left peripheral wall part 82. The left communicating hole 84 communicates the accommodating space 46 (see FIG. 6) of the body housing 40 with the space outside the body housing 40.

Each of the left fixing holes 86 penetrates the left wall 52 in the left-right direction. The four left fixing holes 86 are arranged in the left peripheral wall part 82. The number of the plurality of left fixing holes 86 is equal to the number of the plurality of right fixing holes 78. Each of the four left fixing holes 86 is disposed near a corresponding one of four corners of the left peripheral wall part 82. The left fixing part 72 comprises a left fixing central axis C2 located at a spot equidistant from each of the four left fixing holes 86. A distance from the left fixing central axis C2 to each of the left fixing holes 86 is substantially equal to a distance from the right fixing central axis C1 to each of the right fixing holes 78. About the left fixing central axis C2, the adjacent left fixing holes 86 are apart 90 degrees from each other.

Each of the left positioning protrusions 88 protrudes leftward from the outer surface of the left wall 52. The left positioning protrusions 88 are arranged in the left peripheral wall part 82. The left positioning protrusions 88 are disposed closer to the left fixing central axis C2 than the left fixing holes 86. About the left fixing central axis C2, the two left positioning protrusions 88 are apart 180 degrees from each other.

As shown in FIG. 6, the power unit 2 comprises a control unit 92, a motor housing 94, the prime mover 96, a cooling fan 98, and an output unit 100. Here, an internal structure of the battery pack BP is omitted in illustration in FIG. 6. The control unit 92, the motor housing 94, the prime mover 96, the cooling fan 98, and the output unit 100 are arranged in the accommodating space 46. The control unit 92, the motor housing 94, and the output unit 100 are supported by being interposed between the right body housing 42 (see FIG. 2) and the left body housing 44 (see FIG. 3).

The control unit 92 is configured to operate on power supplied from the battery pack BP. The control unit 92 causes the prime mover 96 to operate in response to the trigger 22 (see FIG. 1) being operated.

The prime mover 96 is accommodated in the motor housing 94. The prime mover 96 is supported by the body housing 40 via the motor housing 94. The prime mover 96 is a motor, for example a brushless motor. In a modification, the prime mover 96 may be an engine. When the trigger 22 (see FIG. 1) is operated while the power unit 2 is in on state, the shaft 102 of the prime mover 96 rotates. As a degree at which the trigger 22 is operated increases, a rotating speed of the shaft 102 gradually rises from zero.

A maximum output of the prime mover 96 may be 0.5 kW or more and 2.0 kW or less, for example may be 0.5 kW or more and 1.5 kW or less, may be 0.5 kW or more and 1.2 kW or less, and may be 0.5 kW or more and 1.0 kW or less. The prime mover 96 according to the present embodiment is a prime mover of low output.

The cooling fan 98 is fixed to the shaft 102. The cooling fan 98 rotates unitedly with the shaft 102. Due to this, the cooling fan 98 pumps air.

The output unit 100 is inserted into an opening at a front end of the body housing 40. The output unit 100 comprises a fixing base part 104 and a clutch part 106. The fixing base part 104 is fixed to the body housing 40. The fixing base part 104 is fixed to the housing 8 (see FIG. 1) of the working unit 4. The clutch part 106 is rotatably supported by the fixing base part 104. The clutch part 106 is fixed to the shaft 102. The clutch part 106 is configured to contact the drum 24 (see FIG. 1) of the working unit 4 when the rotating speed of the shaft 102 becomes a predetermined value or more. Due to this, the rotation of the shaft 102 is transferred to the drum 24 via the clutch part 106 and thus the blade 28 (see FIG. 1) rotates.

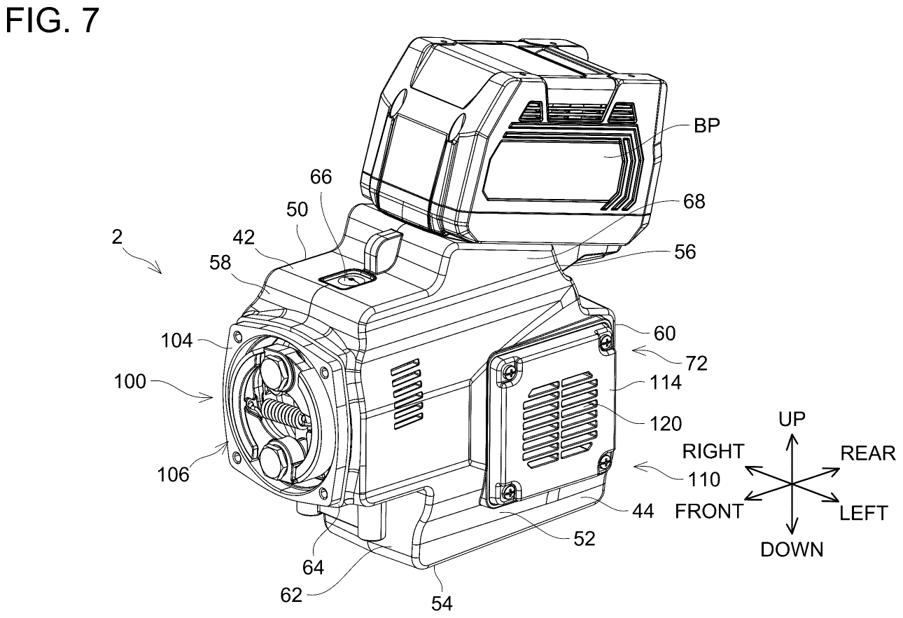

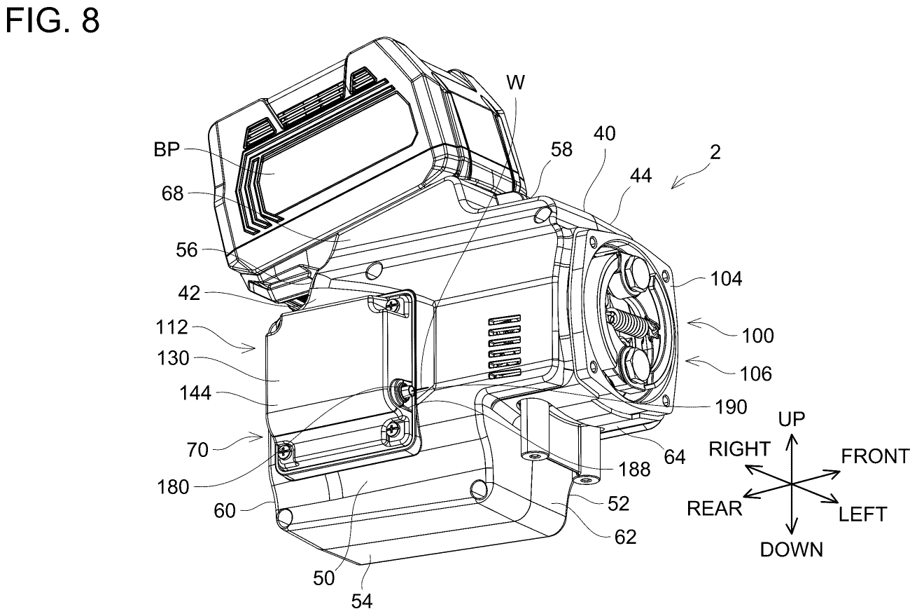

As shown in FIGS. 2 and 3, the power unit 2 comprises the cover unit 110 and the input unit 112. As shown in FIGS. 3 and 7, the cover unit 110 is configured to be fixed to selectively the right fixing part 70 of the right wall 50 and the left fixing part 72 of the left wall 52. As shown in FIGS. 2 and 8, the input unit 112 is configured to be fixed selectively to the right fixing part 70 and the left fixing part 72. As shown in FIGS. 2 and 3, when the cover unit 110 is fixed to the right fixing part 70, the input unit 112 is fixed to the left fixing part 72. As shown in FIGS. 7 and 8, when the cover unit 110 is fixed to the left fixing part 72, the input unit 112 is fixed to the right fixing part 70.

As shown in FIG. 4, the cover unit 110 comprises a cover 114, a guide member 116, and a plurality of cover fixing members 118. When the cover 114 is viewed along the left direction, the cover 114 has a substantially square shape. When the cover unit 110 is fixed to the right wall 50, the cover 114 is surrounded by the right peripheral wall part 74. The cover 114 includes an intake port 120 and a plurality of (four in the present embodiment) cover fixing holes 122.

Each of the intake port 120 and the four cover fixing holes 122 penetrates the cover 114 in the left-right direction. The number of the plurality of cover fixing holes 122 is equal to the number of the plurality of right fixing holes 78. Each of the four cover fixing holes 122 is disposed near a corresponding one of four corners of the cover 114. About the right fixing central axis C1, the adjacent cover fixing holes 122 are apart 90 degrees from each other.

When the guide member 116 is viewed along the left direction, the guide member 116 has a substantially square shape. The guide member 116 is interposed between the right wall 50 of the body housing 40 and the cover 114. The guide member 116 includes an intake path 124, a plurality of (four in the present embodiment) guide fixing holes 126, and a plurality of (four in the present embodiment) guide positioning holes 128.

The intake path 124 communicates via the intake port 120 with the space outside the body housing 40. The intake path 124 has a lower end communicating with the accommodating space 46. When the cooling fan 98 (see FIG. 6) rotates, air passes through the intake port 120 and the intake path 124 and flows into the accommodating space 46. Due to this, the control unit 92 (see FIG. 6) and the prime mover 96 (see FIG. 6) are cooled.

Each of the guide fixing holes 126 and the guide positioning holes 128 penetrates the guide member 116 in the left-right direction. The number of the plurality of guide fixing holes 126 is equal to the number of the plurality of right fixing holes 78. Each of the four guide fixing holes 126 is disposed near a corresponding one of four corners of the guide member 116. About the right fixing central axis C1, the adjacent guide fixing holes 126 are apart 90 degrees from each other.

Each of the four guide positioning holes 128 is disposed near a corresponding one of four corners of the guide member 116. The guide positioning holes 128 are disposed closer to a center of the guide member 116 than the guide fixing holes 126. The guide member 116 is positioned relative to the right wall 50 by each of the right positioning protrusions 80 being inserted into the corresponding one of the guide positioning holes 128. When the cover unit 110 is fixed to the left fixing part 72 (see FIG. 5), the guide member 116 is positioned relative to the left wall 52 by each of the left positioning protrusions 88 (see FIG. 5) being inserted into the corresponding one of the guide positioning holes 128.

The cover fixing members 118 are for example, screws. The cover fixing members 118 are inserted into the cover fixing holes 122 and the guide fixing holes 126 to be screwed with threads of the right fixing holes 78. Due to this, the cover unit 110 is fixed to the right wall 50. In a modification, self-tapping screws may be used as the cover fixing members 118 to fix the cover unit 110 to the right wall 50. Also, when the cover unit 110 is to be fixed to the left wall 52 (see FIG. 5), the cover fixing members 118 are inserted into the left fixing holes 86 (see FIG. 5), the cover fixing holes 122, and the guide fixing holes 126.

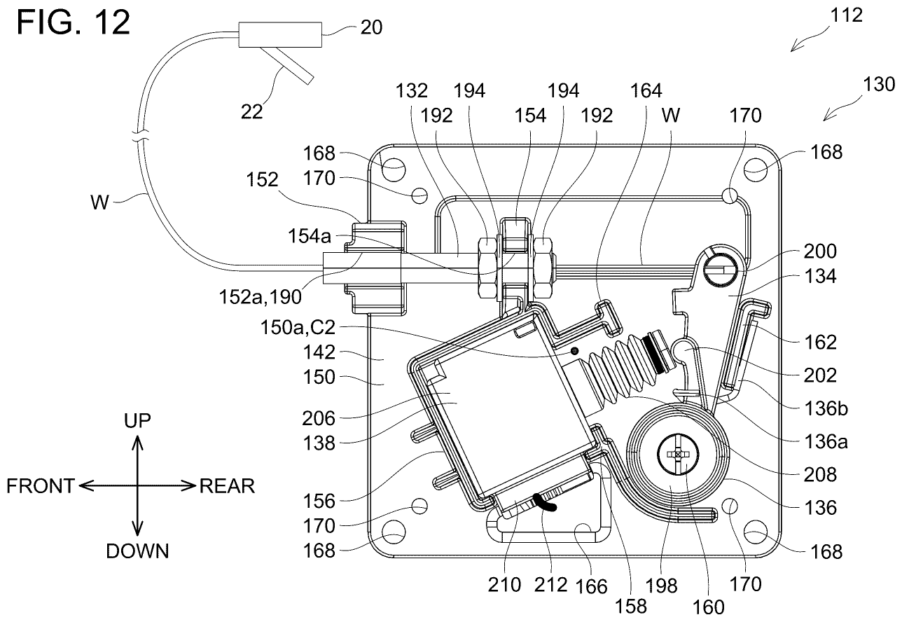

As shown in FIG. 5, the input unit 112 comprises an input unit housing 130, a pipe 132, wire W, a lever 134, a biasing member 136 (FIG. 12), a detector 138, and a plurality of (four in the present embodiment) fixing members 140. The input unit housing 130 comprises the support member 142 and the cover 144.

The support member 142 comprises a base plate part 150, a first guide part 152, a second guide part 154, a first support part 156, a second support part 158, a third support part 160, a first stopper part 162, and a second stopper part 164.

The base plate part 150 has a substantially square shape. The base plate part 150 is interposed between the left wall 52 of the body housing 40 and the cover 144. When the input unit 112 is fixed to the left wall 52, the base plate part 150 is surrounded by the left peripheral wall part 82. The base plate part 150 includes a plate communicating hole 166, a plurality of (four in the present embodiment) plate fixing holes 168, and a plurality of (four in the present embodiment) plate positioning holes 170. Each of the plate communicating hole 166, the plate fixing holes 168, and the plate positioning holes 170 penetrates the base plate part 150 in the left-right direction.

The plate communicating hole 166 is disposed at a lower portion of the base plate part 150. The plate communicating hole 166 faces the left communicating hole 84 in the left-right direction. The plate communicating hole 166 has a substantially right triangle shape.

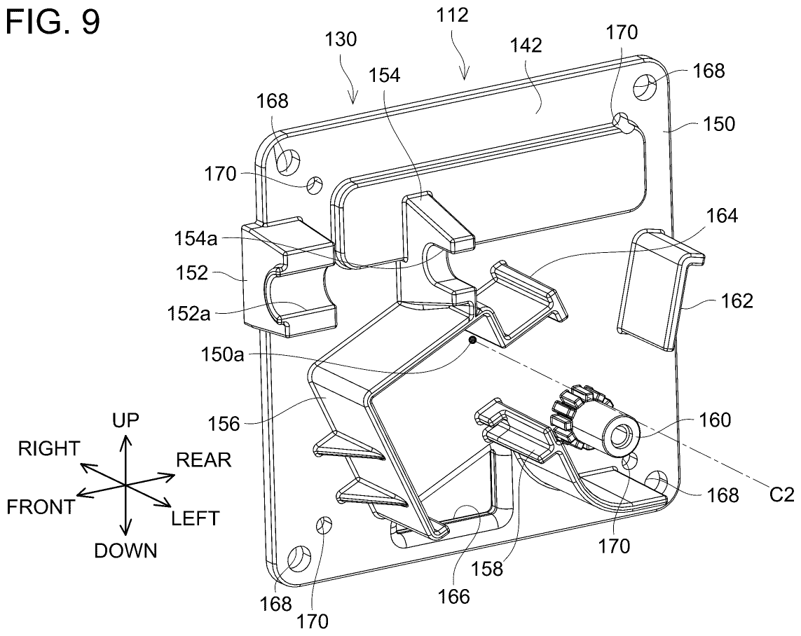

As shown in FIG. 9, the number of the plurality of plate fixing holes 168 is equal to the number of the plurality of left fixing holes 86 (see FIG. 5). Each of the four plate fixing holes 168 is disposed near a corresponding one of four corners of the base plate part 150. A center 150a of the base plate part 150 is disposed on the left fixing central axis C2. The center 150a is located at a spot equidistant from each of the four plate fixing holes 168. A distance from the center 150a to each of the plate fixing holes 168 is substantially equal to a distance from the left fixing central axis C2 to each of the left fixing holes 86. About the left fixing central axis C2, the adjacent plate fixing holes 168 are apart 90 degrees from each other.

The plate positioning holes 170 are disposed closer to the center 150a than the plate fixing holes 168. The center 150a is disposed at a spot equidistant from each of the four plate positioning holes 170. Each of the four plate positioning holes 170 is disposed near a corresponding one of the four plate fixing holes 168. As shown in FIG. 5, the support member 142 is positioned relative to the left wall 52 by each of the left positioning protrusions 88 being inserted into the corresponding one of the plate positioning holes 170. When the input unit 112 is fixed to the right fixing part 70 (see FIG. 4), the support member 142 is positioned relative to the right wall 50 by each of the right positioning protrusions 80 (see FIG. 4) being inserted into the corresponding one of the plate positioning holes 170.

As shown in FIG. 9, each of the first guide part 152, the second guide part 154, the first support part 156, the second support part 158, the third support part 160, the first stopper part 162, and the second stopper part 164 protrudes leftward from the base plate part 150 when the input unit 112 (see FIG. 2) is fixed to the left wall 52 (see FIG. 2), whereas they protrude rightward from the base plate part 150 when the input unit 112 (see FIG. 8) is fixed to the right wall 50 (see FIG. 8). The protruding directions are opposite from each other between when the input unit 112 is fixed to the left wall 52 and when the input unit 112 is fixed to the right wall 50.

The first guide part 152 is disposed below the corner at an upper portion on a front side of the base plate part 150. The first guide part 152 is disposed on a rim of the base plate part 150. The first guide part 152 has a first recess 152a recessed from a tip of the first guide part 152.

The second guide part 154 faces the first guide part 152 in the front-rear direction. The second guide part 154 has a second recess 154a recessed from a tip of the second guide part 154. The second recess 154a is aligned with the first recess 152a in the front-rear direction.

The first support part 156 has a substantially L shape. One end of the first support part 156 is disposed near the plate communicating hole 166. A vicinity of another end of the first support part 156 is connected to the second guide part 154.

The second support part 158 has a curved shape. One end of the second support part 158 is disposed near the plate communicating hole 166. Another end of the second support part 158 is disposed near the corner at a lower portion on a rear side of the base plate part 150.

The third support part 160 has a substantially cylindrical shape. The third support part 160 is disposed near the second support part 158.

The first stopper part 162 has a substantially L shape. The first stopper part 162 faces the second stopper part 164.

The second stopper part 164 has a substantially T shape. The second stopper part 164 protrudes up-and-rearward from the other end of the first support part 156.

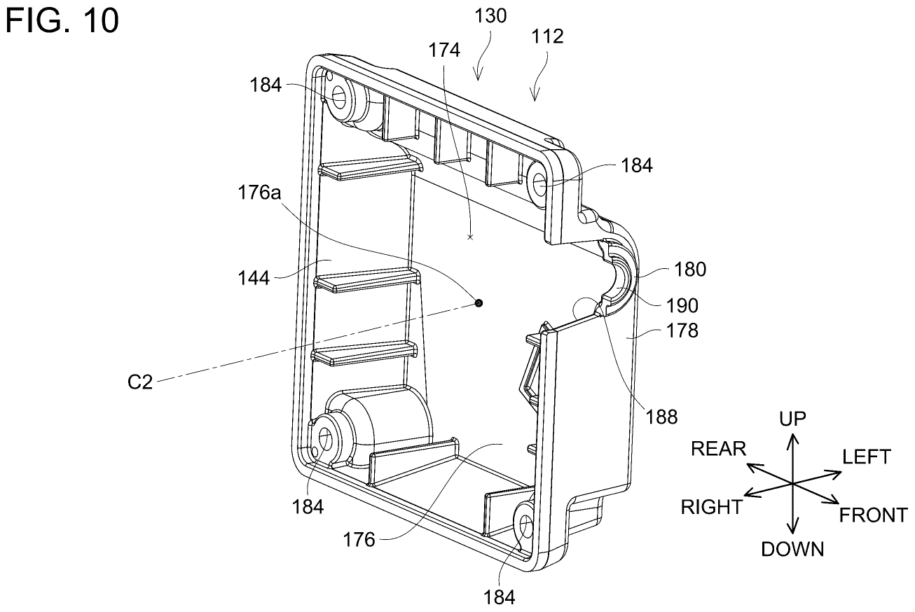

As shown in FIG. 10, the cover 144 has a substantially box shape. The cover 144 defines an internal space 174 between the cover 144 and the support member 142 (see FIG. 9). The cover 144 comprises a bottom part 176, a side part 178, and a third guide part 180.

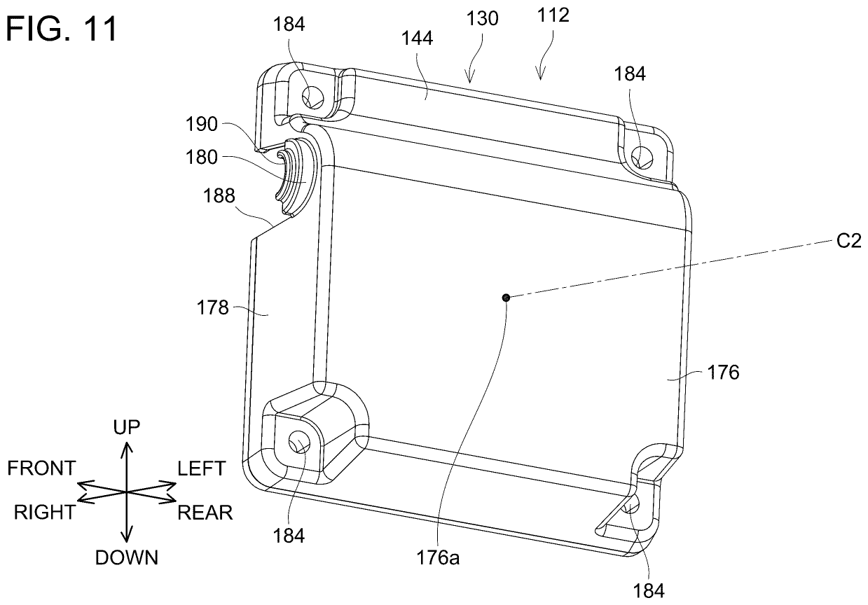

As shown in FIG. 11, when the input unit housing 130 is viewed along the right direction, the bottom part 176 has a substantially square shape. The bottom part 176 faces the support member 142 (see FIG. 9). The bottom part 176 includes a plurality of (four in the present embodiment) cover fixing holes 184 penetrating the bottom part 176 in the left-right direction. The number of the plurality of cover fixing holes 184 is equal to the number of the plurality of left fixing holes 86 (see FIG. 5). Each of the four cover fixing holes 184 is disposed near a corresponding one of four corners of the bottom part 176. A center 176a of the bottom part 176 is disposed on the left fixing central axis C2. The center 176a is located at a spot equidistant from each of the four cover fixing holes 184. A distance from the center 176a to each of the cover fixing holes 184 is substantially equal to a distance from the left fixing central axis C2 to each of the left fixing holes 86 (see FIG. 5). About the left fixing central axis C2, the adjacent cover fixing holes 184 are apart 90 degrees from each other.

The side part 178 protrudes rightward from a rim of the bottom part 176. The side part 178 surrounds an entirety of the rim of the bottom part 176. When the input unit 112 is fixed to the left wall 52 (see FIG. 5), the side part 178 is surrounded by the left peripheral wall part 82 (see FIG. 5).

The input unit housing 130 comprises the draw-in part 188, and the draw-in part 188 is defined at the side part 178. The draw-in part 188 is arranged near the corner at an upper portion on a front side of the bottom part 176. The draw-in part 188 penetrates a front wall of the side part 178 in the front-rear direction. The draw-in part 188 is a through hole.

The third guide part 180 is arranged at one portion of the draw-in part 188. The third guide part 180 has a substantially semi-cylindrical shape. As shown in FIG. 5, the third guide part 180 is in contact with the tip of the first guide part 152. The first guide part 152 is arranged in the draw-in part 188. Due to this, a draw-in hole 190 is defined by the third guide part 180 and the first recess 152a of the first guide part 152. The draw-in hole 190 is a portion of the draw-in part 188. The draw-in hole 190 communicates an outside of the input unit housing 130 with the internal space 174 (see FIG. 10).

The pipe 132 is interposed between the first guide part 152 and the third guide part 180. As shown in FIG. 12, the pipe 132 is received by the first recess 152a and the second recess 154a. The pipe 132 has a substantially cylindrical shape. The pipe 132 is fixed to the second guide part 154 by two nuts 192 and two washers 194.

The wire W is inserted into the pipe 132. Due to this, the wire W passes through the draw-in part 188 (see FIG. 10), by which the wire W is pulled from the space outside the input unit housing 130 and drawn into the internal space 174 (see FIG. 10). One end of the wire W is fixed to the trigger 22. Another end of the wire W is fixed to the lever 134.

The lever 134 comprises a pivoting part 198, a wire fixing part 200, and a switch operating part 202. The pivoting part 198 is pivotably attached to the third support part 160. The wire fixing part 200 protrudes from the pivoting part 198. A tip of the wire fixing part 200 is fixed to another end of the wire W. When the lever 134 pivots, the wire fixing part 200 moves between the first stopper part 162 and the second stopper part 164. The switch operating part 202 protrudes from the switch operating part 202 toward the detector 138.

The biasing member 136 is attached to the lever 134. The biasing member 136 is for example a torsion spring. One end 136a of the biasing member 136 is latched to the switch operating part 202. Another end 136b of the biasing member 136 is latched to the first stopper part 162. The biasing member 136 biases the lever 134 toward a spot where the wire fixing part 200 contacts the first stopper part 162.

The detector 138 is for example a push-in switch. The detector 138 comprises a body part 206, a switch part 208, and a wiring connecting part 210. The body part 206 has a substantially cuboid shape. The body part 206 is supported by the first support part 156 and the second support part 158 by being at least partially surrounded by the first support part 156 and the second support part 158.

The switch part 208 is disposed on a side surface of the body part 206. The switch part 208 is pushed in by the switch operating part 202.

The wiring connecting part 210 is disposed on the side surface of the body part 206. The wiring connecting part 210 adjoins the plate communicating hole 166. The wiring connecting part 210 is connected to the control unit 92 (see FIG. 6) via wiring 212. The wiring 212 passes through the plate communicating hole 166.

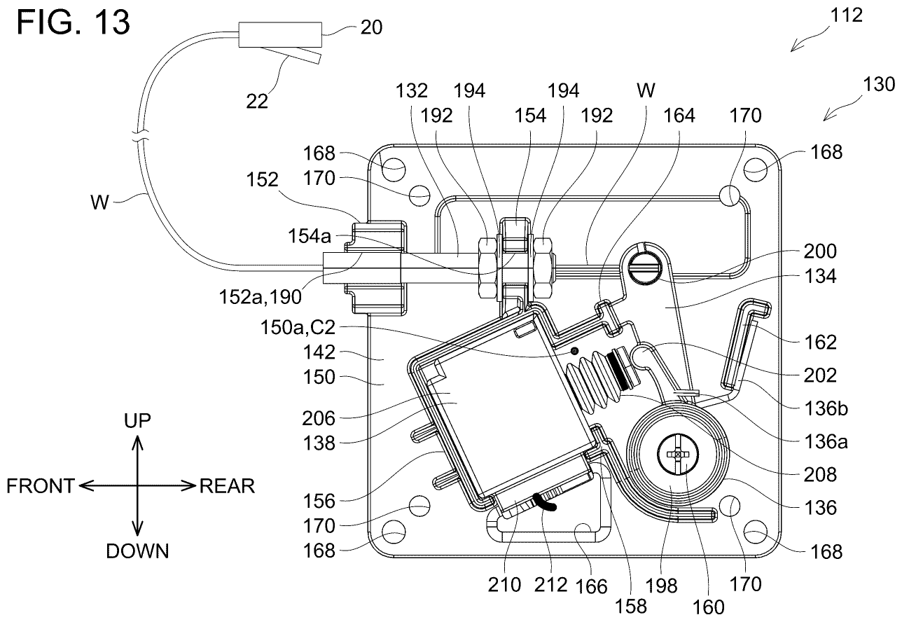

When the trigger 22 is not operated by a user, the wire fixing part 200 is in contact with the first stopper part 162 due to biasing force of the biasing member 136. When the trigger 22 is operated as shown in FIG. 13, the wire W is drawn in, by which the other end of the wire W moves toward the first guide part 152 and the second guide part 154 (i.e., the draw-in part 188). The wire fixing part 200 moves toward the second stopper part 164, by which the lever 134 moves. At this occasion, the switch operating part 202 pushes the switch part 208 in. Due to this, the detector 138 detects that the other end of the wire W is moving toward the draw-in part 188, i.e., the wire W has been drawn in. The trigger 22 is configured capable of being operated until the wire fixing part 200 contacts the second stopper part 164. When the wire fixing part 200 contacts the second stopper part 164, the lever 134 can no longer move. Due to this, the switch part 208 is pushed in to a predetermined spot. Due to this, the detector 138 can be suppressed from being pushed in beyond the predetermined spot, thereby suppressing the detector 138 from being broken/damaged. A signal according to a degree at which the switch part 208 is pushed in (signal according to the degree at which the trigger 22 is operated) is sent to the control unit 92 (see FIG. 6) via the wiring 212. The control unit 92 controls the rotation speed of the shaft 102 of the prime mover 96 according to the received signal.

As shown in FIG. 5, the fixing members 140 are for example screws. The fixing members 140 are inserted into the plate fixing holes 168 and the cover fixing holes 184 to be screwed with threads of the left fixing holes 86. Due to this, the input unit 112 is fixed to the left wall 52. Also, when the input unit 112 is fixed to the right wall 50 (see FIG. 4), the fixing members 140 are inserted into the right fixing holes 78, the plate fixing holes 168, and the cover fixing holes 184.

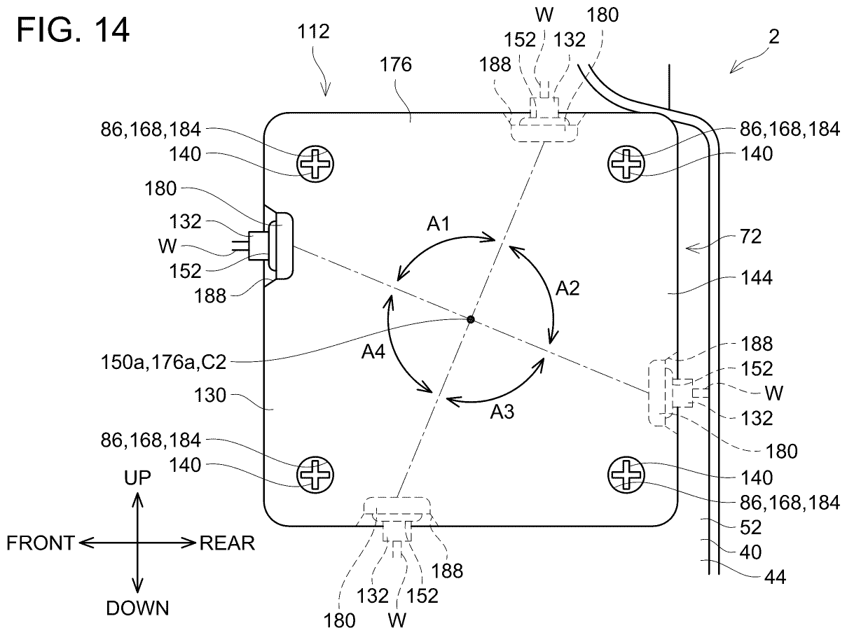

As shown in FIG. 14, the input unit 112 is configured to be fixed to the left wall 52 selectively in four arrangements by modified combinations of the left fixing holes 86, the plate fixing holes 168, and the cover fixing holes 184. In a first arrangement, the draw-in part 188 is oriented frontward. In a second arrangement, the draw-in part 188 is oriented upward. In a third arrangement, the draw-in part 188 is oriented rearward. In a fourth arrangement, the draw-in part 188 is oriented downward. The input unit 112 in the first arrangement is arranged rotationally symmetric with respect to the left fixing central axis C2 relative to each of the input unit 112 in the second arrangement, the input unit 112 in the third arrangement, and the input unit 112 in the fourth arrangement. Since the adjacent left fixing holes 86 are apart 90 degrees from each other about the left fixing central axis C2, an angle A1 about the left fixing central axis C2 between the draw-in part 188 in the first arrangement and the draw-in part 188 in the second arrangement is 90 degrees. Also, the angle A1 is equal to each of an angle A2 about the left fixing central axis C2 between the draw-in part 188 in the second arrangement and the draw-in part 188 in the third arrangement, an angle A3 about the left fixing central axis C2 between the draw-in part 188 in the third arrangement and the draw-in part 188 in the fourth arrangement, and an angle A4 about the left fixing central axis C2 between the draw-in part 188 in the fourth arrangement and the draw-in part 188 in the first arrangement.

Also, the input unit 112 is configured to be fixed to the right wall 50 (see FIG. 8) selectively in four arrangements by modified combinations of the right fixing holes 78, the plate fixing holes 168, and the cover fixing holes 184. As shown in FIG. 8, in the first arrangement, the draw-in part 188 is oriented frontward. Although not shown, in the second arrangement, the draw-in part 188 is oriented upward. In the third arrangement, the draw-in part 188 is oriented rearward. In the fourth arrangement, the draw-in part 188 is oriented downward. Also, the input unit 112 in the first arrangement is arranged rotationally symmetric with respect to the right fixing central axis C1 relative to each of the input unit 112 in the second arrangement, the input unit 112 in the third arrangement, and the input unit 112 in the fourth arrangement.

As shown in FIG. 4, in the cover unit 110, the guide member 116 is fixed to the right wall 50 or the left wall 52 (see FIG. 7) in a specific arrangement where a lower end of the intake path 124 is oriented downward. Due to this, at the cover unit 110, only the cover 114 is configured to be fixed to the right wall 50 selectively in four arrangements and be fixed to the left wall 52 selectively in four arrangements.

### Effects

The power unit 2 according to the present embodiment comprises: the prime mover 96; the body housing 40 supporting the prime mover 96; and the input unit 112 configured to control the prime mover 96. The input unit 112 comprises the input unit housing 130 having the internal space 174 and comprising the draw-in part 188 configured to draw in the wire W from outside the input unit housing 130 into the internal space 174; and the cover fixing holes 184 and the fixing members 140 (example for a fixing part) configured to fix the input unit housing 130 to the body housing 40. The input unit housing 130 is configured to be fixed to the body housing 40 selectively in any arrangement among at least two arrangements.

According to the above configuration, the arrangement of the draw-in part 188 relative to the body housing 40 can be adjusted by changing the arrangement of the input unit housing 130 relative to the body housing 40. Due to this, the draw-in part 188 can be placed in a suitable arrangement according to the type of the working unit 4 when the power unit 2 is used in the working unit 4

The at least two arrangements include the first arrangement and the second arrangement different from the first arrangement. The input unit 112 in the first arrangement is disposed rotationally symmetric to the input unit 112 in the second arrangement with respect to the left fixing central axis C2 (example for a fixing central axis).

According to the above configuration, no matter what arrangement the input unit 112 is in, a distance between the draw-in part 188 and the left fixing central axis C2 can be made constant.

The at least two arrangements further comprise the third arrangement different from the first and second arrangements. The input unit 112 in the third arrangement is disposed rotationally symmetric to the input unit 112 in the first arrangement with respect to the left fixing central axis C2. An angle about the left fixing central axis C2 between the draw-in part 188 in the first arrangement and the draw-in part 188 in the second arrangement is same as an angle about the left fixing central axis C2 between the draw-in part 188 in the second arrangement and the draw-in part 188 in the third arrangement.

According to the above configuration, the arrangement of the input unit 112 relative to the body housing 40 can be easily adjusted.

The body housing 40 comprises the right wall 50 (example for a first outer wall) to which the input unit housing 130 is configured to be fixed, and the left wall 52 (example for a second outer wall) to which the input unit housing 130 is configured to be fixed and being different from the right wall 50.

According to the above configuration, an outer wall for fixing the input unit housing 130 can be selected from among the right wall 50 and the left wall 52 depending on the type of the working unit 4. Due to this, the draw-in part 188 can be placed in a suitable arrangement depending on the type of the working unit 4.

The wire W is configured to move relative to the draw-in part 188. The input unit 112 further comprises the detector 138 disposed in the internal space 174 and configured to detect movement of the wire W.

According to the above configuration, the input unit 112 can be suppressed from being large in size as compared to a configuration where the detector 138 is disposed outside the input unit housing 130.

The input unit 112 further comprises the lever 134 fixed to the wire W and configured to operate the detector 138 when the wire W moves relative to the draw-in part 188.

In a configuration where the wire W directly operates the detector 138, there may be an erroneous operation on the detector 138 due to vibration of the wire W, for example. According to the above configuration, because the lever 134 operates the detector 138, the detector 138 can be suppressed from being erroneously operated.

The prime mover 96 is a motor.

Typically, because a motor is smaller than an engine, the body housing 40 is small. According to the above configuration, in the body housing 40 which is small, the draw-in part 188 can be placed in a suitable arrangement depending on the type of the working unit 4.

### Second Embodiment

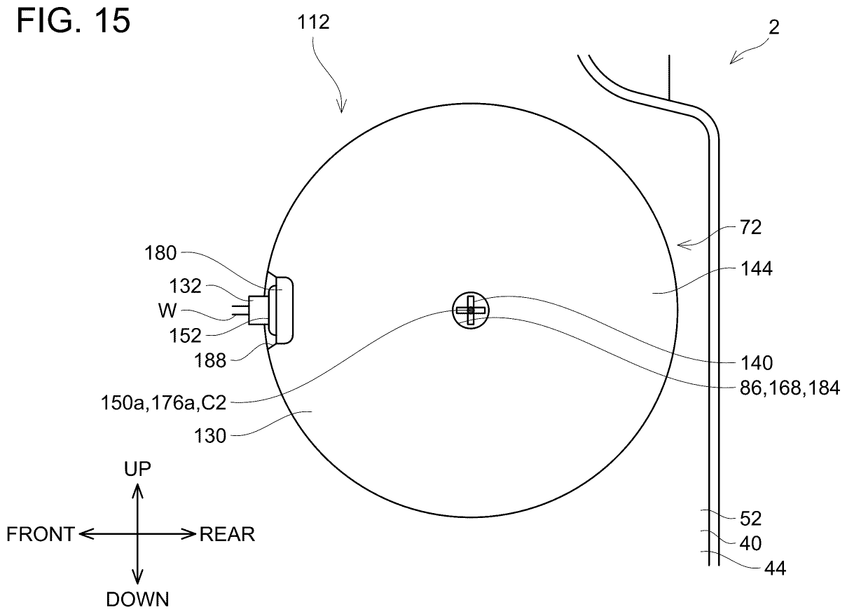

In a second embodiment, only different points from the first embodiment will be described. As shown in FIG. 15, an input unit 112 is fixed to a left wall 52 by one fixing member 140. The fixing member 140 is disposed on a left fixing central axis C2. After a draw-in part 188 has been adjusted to a desired orientation by the input unit 112 being rotated about the left fixing central axis C2, the fixing member 140 is inserted into an input unit housing 130 on the left fixing central axis C2 to be screwed to the left wall 52. Due to this, an arrangement of the input unit 112 is adjusted to a desired arrangement. Although not shown, the input unit 112 is configured to be fixed to a right wall 50 by the fixing member 140 being inserted into the input unit housing 130 on a right fixing central axis C1 and screwed with the right wall 50 (see FIG. 4).

### Third Embodiment

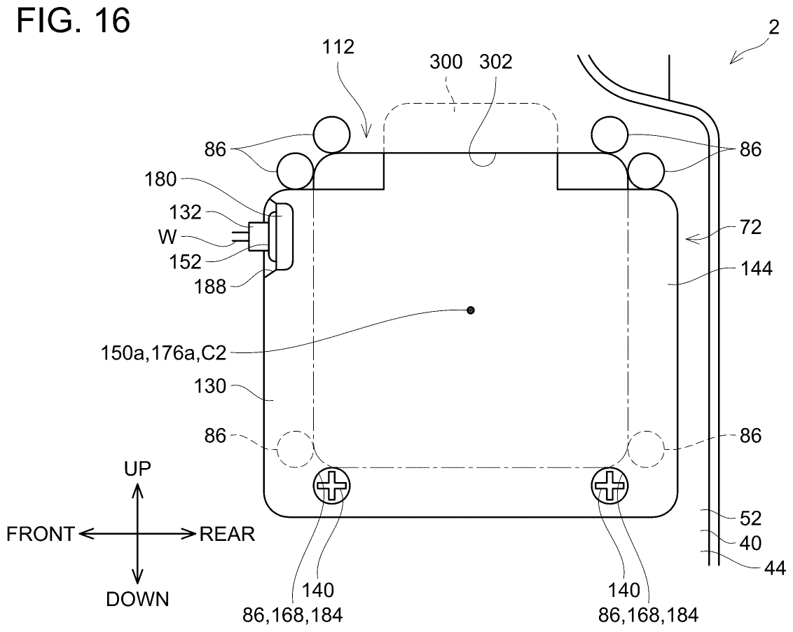

In a third embodiment, only different points from the first embodiment will be described. As shown in FIG. 16, a cover 144 of an input unit housing 130 comprises an insert part 300. A left wall 52 comprises an insert receptacle part 302 configured for insertion of the insert part 300.

The cover 144 has two cover fixing holes 184. Each of the two cover fixing holes 184 is disposed near its corresponding corner, being two of four corners of a bottom part 176.

When the input unit 112 is to be fixed to the left wall 52, firstly the insert part 300 is inserted into the insert receptacle part 302. Next, each of the two fixing members 140 is inserted into corresponding ones of the cover fixing holes 184 and plate fixing holes 168 and then screwed with threads of left fixing holes 86. Due to this, the insert part 300 is suppressed from being slipping out of the insert receptacle part 302. As a result of this, the input unit 112 is fixed to the left wall 52.

Although not shown, a right wall 50 (see FIG. 4) comprises an insert receptacle part having the same configuration as that of the insert receptacle part 302 of the left wall 52. Due to this, the input unit 112 is configured to be fixed to the right wall 50 by the insertion structure between the insert part 300 and the insert receptacle part of the right wall 50.

### Modifications

The working unit 4 according to an aspect may not be limited to a grass cutter, but may be a lawn mower, a hedge trimmer, a blower, a cart, a snowplow, a tiller, an edger, a winch, a concrete vibrator, a screed, a rammer, a plate compactor, or a power trowel.

The input unit 112 according to an aspect may be configured to be fixed selectively to the right wall 50 and the left wall 52 in any arrangement among two arrangements, three arrangements, or five arrangements or more. When the input unit 112 is configured to be fixed selectively to the right wall 50 or the left wall 52 in N arrangements, the angle A1 may be 360/N degrees. For example, when Nis 2, the angle A1 is 180 degrees, and when N is 3, the angle A1 is 120 degrees.

In the input unit 112 according to an aspect, the angles A1, A2, A3, and A4 may not be equal to each other, but may be different angles, for example.

In the input unit 112 according to an aspect, the right fixing holes 78 may not be disposed near the corners of the right peripheral wall part 74. For example, the right fixing hole(s) 78 may be disposed near a center between two corners of the right peripheral wall part 74, thus they may be disposed at spot(s) offset toward the center from the spots of the right fixing holes 78 according to the first embodiment. Moreover, the left fixing holes 86 may not be disposed near the corners of the left peripheral wall part 82. For example, the left fixing hole(s) 86 may be disposed near a center between two corners of the left peripheral wall part 82, thus may be disposed at spot(s) offset toward the center from the spots of the left fixing holes 86 according to the first embodiment.

The input unit 112 according to an aspect may be fixed to selectively the right wall 50 and the left wall 52 by using two or three fixing members 140 alone. In this case, the fixing members 140 are not inserted into a part of the right fixing holes 78 and a part of the left fixing holes 86.

The fixing members 140 according to an aspect may comprise pins and retaining members, instead of the screws. In this case, the input unit 112 may be fixed selectively to the right wall 50 and the left wall 52 by the pins and the retaining members. Also, the plurality of fixing members 140 may comprise both screw(s) and pin(s) and retaining member(s).

The detector 138 according to an aspect may be a contact-less detector, for example a light blocking sensor. Also, the detector 138 may be a magnetic sensor comprising a Hall element and a magnet.

The detector 138 according to an aspect may be configured to detect whether the switch part 208 is pressed in or not instead of being configured to detect the degree at which the switch part 208 is pressed in. In such a configuration, the control unit 92 causes the prime mover 96 to rotate at a constant rotating speed no matter what degree the switch part 208 is pressed in at.

What is claimed is:

1. A power unit comprising:
a prime mover;
a body housing supporting the prime mover; and
an input unit configured to control the prime mover,
wherein
the input unit comprises:
an input unit housing having an internal space and comprising a draw-in part configured to draw in the wire from outside the input unit housing into the internal space; and
a fixing part configured to fix the input unit housing to the body housing, and
the input unit housing is configured to be fixed to the body housing selectively in any arrangement among at least two arrangements.

2. The power unit according to claim 1, wherein
the at least two arrangements comprise:
a first arrangement; and
a second arrangement different from the first arrangement, and
the input unit in the first arrangement is disposed rotationally symmetric to the input unit in the second arrangement with respect to a fixing central axis.

3. The power unit according to claim 2, wherein
the at least two arrangements further comprise a third arrangement different from the first arrangement and the second arrangement,
the input unit in the third arrangement is disposed rotationally symmetric to the input unit in the first arrangement with respect to the fixing central axis, and
an angle about the fixing central axis between the draw-in part of the input unit in the first arrangement and the draw-in part of the input unit in the second arrangement is same as an angle about the fixing central axis between the draw-in part of the input unit in the second arrangement and the draw-in part of the input unit in the third arrangement.

4. The power unit according to claim 1, wherein
the body housing comprises:
a first outer wall to which the input unit housing is configured to be fixed; and
a second outer wall to which the input unit housing is configured to be fixed and being different from the first outer wall.

5. The power unit according to claim 1, wherein
the wire is configured to move relative to the draw-in part, and
the input unit further comprises a detector disposed in the internal space and configured to detect movement of the wire.

6. The power unit according to claim 5, wherein the input unit further comprises a lever fixed to the wire and configured to operate the detector when the wire moves relative to the draw-in part.

7. The power unit according to claim 1, wherein the prime mover is a motor.

8. The power unit according to claim 3, wherein
the body housing comprises:
a first outer wall to which the input unit housing is configured to be fixed; and
a second outer wall to which the input unit housing is configured to be fixed and being different from the first outer wall,
the wire is configured to move relative to the draw-in part,
the input unit further comprises:
a detector disposed in the internal space and configured to detect movement of the wire; and
a lever fixed to the wire and configured to operate the detector when the wire moves relative to the draw-in part, and
the prime mover is a motor.
